(19) United States
(12) Patent Application Publication
(10) Pub. No.: US 2026/0269613 A1
(43) Pub. Date: Sep. 10, 2026

(54) POWER CONVERSION DEVICE

(71) Applicant: SANSHA ELECTRIC MANUFACTURING CO., LTD., Osaka (JP)

(72) Inventors: Takehiro MIYAKE, Osaka (JP); Kazunori DOI, Osaka (JP); Kazumasa HAKU, Osaka (JP)

(73) Assignee: SANSHA ELECTRIC MANUFACTURING CO., LTD., Osaka (JP)

(21) Appl. No.: 19/552,926

(22) Filed: Feb. 27, 2026

(30) Foreign Application Priority Data
Mar. 4, 2025 (JP) 2025-033888

(51) Int. Cl. H02J 3/001; H02J 3/48; H02J 101/22; H02J 101/30

(52) U.S. Cl. CPC H02J 3/00125; H02J 3/48; H02J 2101/22; H02J 2101/30

(57) ABSTRACT

The power conversion device includes: an inverter that converts DC power into AC power outputted to a commercial power grid; and an inverter control unit that controls the inverter by virtual synchronous generator control, simulating driving of a synchronous generator based on an active power command value. The inverter control unit includes: an active power command value limiting unit that at detection of a drop in a voltage of the commercial power grid, limits the magnitude of the active power command value; and an active power command value limit calculation unit. The active power command value limiting unit and the active power command value limit calculation unit perform limitation that makes the active power command value smaller than the active power command value before the detection. The inverter control unit controls the inverter based on the active power command value limited by the active power command value limiting unit.

### BACKGROUND OF THE INVENTION

### TECHNICAL FIELD

The present invention relates to a power conversion device provided between a distributed power supply and a system like a commercial power grid, in, for example, a power supply system.

### DESCRIPTION OF THE RELATED ART

So far, a power supply system in which a distributed power supply, such as a solar power generator or a fuel cell power generator, is connected to a system, such as a commercial power grid, has been known. Most distributed power supplies do not have inertial energy that is rotation energy, thus possessing transient characteristics different from those of synchronous generators. An increase in the number and scale of distributed power supplies, therefore, invites a decrease in inertial energy in the entire power supply system, making it difficult for the power supply system to operate stably by tracking a system disturbance or the like.

Thus, for the power supply system, a so-called virtual synchronous generator function has been proposed, which is the function to virtually impart rotation energy to the power conversion device provided between the distributed power supply and the system to simulate driving of a synchronous generator, thereby giving the power conversion device transient characteristics similar to those of the synchronous generator to ensure stable control (see, for example, WO 2023/233456 A).

Specifically, the virtual synchronous generator function calculates a virtual internal phase, which is an internal phase in the case of regarding the power conversion device including the distributed power supply as the synchronous generator, from an active power command value, which is one of parameters (command values) given by the control side of the power supply system, a system frequency, and power output to the system. In the power conversion device having the virtual synchronous generator function, driving of the synchronous generator is simulated by controlling an output voltage on the basis of the virtual internal phase.

Active power output, which is active power in the power conversion device as a virtual synchronous generator, has a correlation with a phase angle, which is a difference between the virtual internal phase and a phase with respect to the system (system phase), as in the case of an real synchronous generator, and this correlation is described as an oscillation equation indicating the dynamic characteristics of the power conversion device. The oscillation equation is plotted as a power-phase angle curve in the form of a sinusoidal curve on a coordinate plane defined by the active power output and the phase angle. On this coordinate plane, the dynamic characteristics of the power conversion device are shown as an operating point moving on the power-phase angle curve.

The power conversion device as the virtual synchronous generator, on the other hand, operates based on the active power command value, and this active power command value is plotted as a straight line representing a constant of active power output on the coordinate plane.

These facts reveal a fact that in the power conversion device as the virtual synchronous generator, a convergence point, at which the moving operating point stabilizes at a constant position, is a point at which the active power output indicated by the power-phase angle curve matches the active power command value, and an intersection on a stabler side where the phase angle is smaller is used as an equilibrium point to realize a stable operation.

### SUMMARY OF THE INVENTION

The power conversion device having the virtual synchronous generator function according to the conventional technique has the following problems. When a system short circuit fault occurs in the power supply system, a temporary drop in a system voltage results, which causes the active power output to fluctuate. The fluctuation of the active power output leads to oscillation of the operating point, that is, oscillation of the phase angle. Usually, after a given time elapses, the phase angle converges to the position of the equilibrium point and the active power output stabilizes, and therefore the power conversion device returns to its normal operation state.

However, when the amplitude of oscillation of the phase angle becomes too large, the phase angle continues to increase without converging to the position of the equilibrium point, in which case the power conversion device as the virtual synchronous generator falls into a so-called step-out state.

A main object of the present invention is to provide a power conversion device that, even when a system short circuit fault occurs, can prevent the power conversion device as a virtual synchronous generator from falling into a step-out state.

A first aspect of the present invention provides a power conversion device including: an inverter that converts DC power of a DC power supply into AC power and that outputs the AC power to a system; and an inverter control unit that controls the inverter by virtual synchronous generator control simulating driving of a synchronous generator, based on an active power command value. The inverter control unit includes an active power command value limiting unit that when a drop in a voltage of the system is detected, limits a magnitude of the active power command value inputted from outside to the inverter control unit. The active power command value limiting unit performs limitation that makes the active power command value smaller than the active power command value before the detection, and the inverter control unit controls the inverter, based on the active power command value limited by the active power command value limiting unit.

A second aspect of the present invention is the power conversion device includes: an inverter that converts DC power of a DC power supply into AC power and that outputs the AC power to a system; and an inverter control unit that controls the inverter by virtual synchronous generator control simulating driving of a synchronous generator, based on an active power command value. The inverter control unit includes: an active power command value limiting unit that when a drop in a voltage of the system is detected, limits a magnitude of the active power command value inputted from outside to the inverter control unit; and an active power command value limit calculation unit that generates an active power command value limit Plim that is an active power command value for comparison, the active power command value limit Plim being set based on a voltage of the system. The active power command value limiting unit compares a first active power command value Pref that is the active power command value inputted from the outside with the active power command value limit Plim, and when Pref ≤ Plim holds, sets the first active power command value Pref to a second active power command value P’ref that is the active power command value satisfying P'ref = Pref, and when Pref > Plim holds, limits the first active power command value Pref to the active power command value limit Plim, as the second active power command value P’ref.

A third aspect of the present invention is the power conversion device according to the first aspect of the present invention, in which the active power command value limiting unit limits a magnitude of the active power command value inputted from outside, to a magnitude smaller than the magnitude of the active power command value before the detection, according to a conversion table stored in the inverter control unit.

A fourth aspect of the present invention is the power conversion device according to the first aspect or second aspect of the present invention, in which when a voltage of the system having risen again is detected after the magnitude of the active power command value is limited, the active power command value limiting unit causes the active power command value to return to a value larger than the limited active power command value.

A fifth aspect of the present invention provides a power conversion device including: an inverter that converts DC power of a DC power supply into AC power and that outputs the AC power to a system; and an inverter control unit that controls the inverter by virtual synchronous generator control simulating driving of a synchronous generator, based on an active power command value. The inverter control unit includes an active power command value limiting unit that when a drop in a voltage of the system is detected, limits a magnitude of the active power command value inputted from outside to the inverter control unit. The active power command value limiting unit performs limitation such that after a drop in the voltage of the system is detected, the active power command value is caused to change in such a way as to decrease with time and that when the voltage of the system having risen again is detected, the active power command value is caused to return to a value larger than the limited active power command value. The inverter control unit controls the inverter, based on the active power command value limited by the active power command value limiting unit.

A sixth aspect of the present invention is the power conversion device according to any one of the first aspect, the second aspect, or the fifth aspect of the present invention, in which the system is a commercial power grid.

The present invention can provide the power conversion device that, even when a system short circuit fault occurs, can prevent the power conversion device as a virtual synchronous generator from falling into a step-out state.

The above-described object, other objects, features, and advantages of the present invention will further be made clear by the following description of modes for carrying out the invention, which description is made with reference to the drawings.

### BRIEF DESCRIPTION OF THE DRAWINGS

FIG. 1 is a block diagram of a configuration of a power supply system including a power conversion device according to an embodiment of the present invention;

FIG. 2 is a block diagram of a configuration of an inverter control unit according to the embodiment of the present invention;

FIG. 3 is a flowchart showing an operation of the power conversion device according to the embodiment of the present invention;

FIG. 4 depicts transition of an operating point in a power conversion device of a conventional configuration;

FIG. 5 depicts transition of the operating point in the power conversion device of the conventional configuration;

FIG. 6 depicts transition of an operating point in the power conversion device according to the embodiment of the present invention; and

FIG. 7 depicts an example of a conversion table used in the power conversion device according to the embodiment of the present invention.

### DETAILED DESCRIPTION

Hereinafter, a power conversion device of the present invention will be described by referring to an embodiment of the present invention.

### Power Supply System

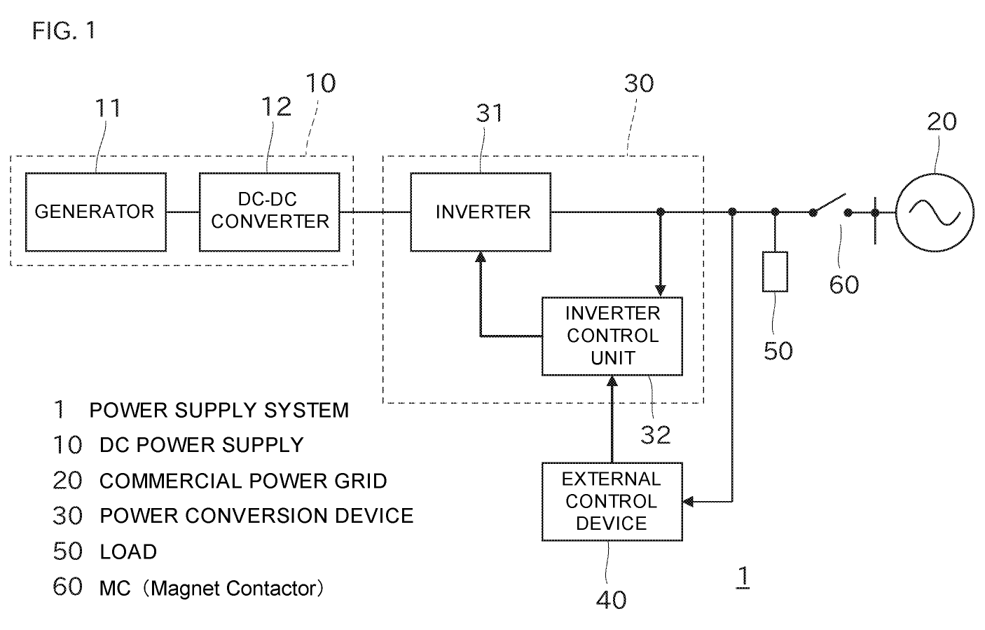

A power supply system including the power conversion device according to the embodiment of the present invention will be described. FIG. 1 is a block diagram of a configuration of a power supply system 1. As shown in FIG. 1, the power supply system 1 includes a DC power supply 10, a commercial power grid 20, a power conversion device 30, and an external control device 40. Further, in the power supply system 1, a load 50 is connected between the power conversion device 30 and the commercial power grid 20, and a magnetic contactor (MC) 60, which is opened and closed by external control, is provided between the load 50 and the commercial power grid 20 to control electrical conduction. Based on control by the external control device 40, the power supply system 1 controls power exchange between the DC power supply 10 and the commercial power grid 20 with respect to the load 50.

The DC power supply 10 is, for example, a distributed power supply, such as a solar power generator, a fuel cell power generator, and a storage battery device, and includes a generator 11 and a DC-DC converter 12 that converts a voltage of the generator 11 into a given value. For simpler description, FIG. 1 shows the DC power supply 10 having only one set of the generator 11 and the DC-DC converter 12. However, the DC power supply 10 may have multiple sets of generators 11 and DC-DC converters 12.

The power conversion device 30 is connected between the DC power supply 10 and the commercial power grid 20. The power conversion device 30 performs power conversion between DC power, which is output or input from or to the DC power supply 10, and AC power, which is output or input from or to the commercial power grid 20. The power conversion device 30 is configured to be capable of performing an interconnection operation, in which the DC power supply 10 and the commercial power grid 20 are operated in their interconnected state, and a self-sustained operation, in which the DC power supply 10 is operated independently of the commercial power grid 20.

When performing the interconnection operation, the power conversion device 30 supplies power to the load 50 as the DC power supply 10 and the commercial power grid 20 exchange power with each other. In the interconnection operation, the power conversion device 30 performs virtual synchronous generator control to simulate driving of a synchronous generator.

In the self-sustained operation, the DC power supply 10 is disconnected from the commercial power grid 20, so that the power conversion device 30 operates to supply power from the DC power supply 10 to the load 50.

The external control device 40 is a unit that acquires parameters, such as a voltage, a current, and a phase, that are related to an alternating current exchanged between the power conversion device 30 and the commercial power grid 20, and that generates various command values for controlling the power conversion device, based on these parameters. Types of command values will be described later when necessary.

### Power Conversion Device

As shown in FIG. 1, the power conversion device 30 includes an inverter 31 and an inverter control unit 32.

The inverter 31 is a unit that is directly connected between the DC power supply 10 and the commercial power grid 20 and that converts DC power of the DC power supply 10 into AC power, based on operation of switching elements (not illustrated), and makes adjustment to allow power exchange between the DC power supply 10 and the commercial power grid 20.

The inverter control unit 32 is a unit that controls the operation of the inverter 31, based on various command values and the like outputted from the external control device 40. Specifically, it is a unit that generates a switching control signal Dg for controlling the switching operation of the inverter control unit 32.

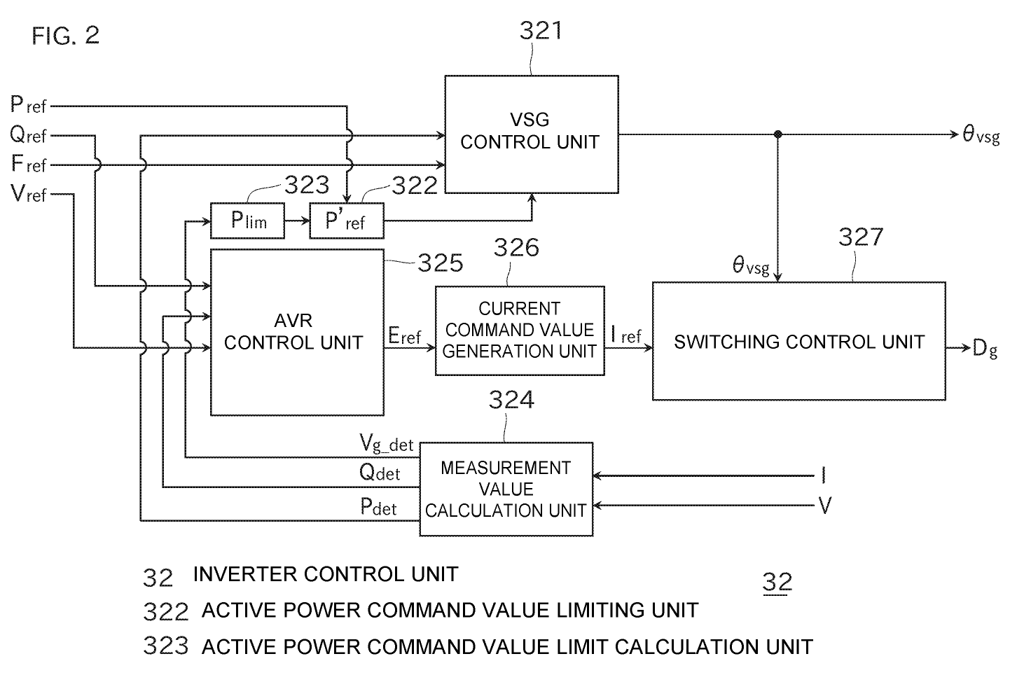

FIG. 2 is a block diagram of a configuration of the inverter control unit 32. As shown in FIG. 2, the inverter control unit 32 includes a virtual synchronous generator control unit (VSG control unit) 321, an active power command value limiting unit 322, an active power command value limit calculation unit 323, a measurement value calculation unit 324, an automatic voltage regulator control unit (AVR control unit) 325, a current command value generation unit 326, and a switching control unit 327.

The VSG control unit 321 is a unit that generates a virtual internal phase that is an internal phase in the power conversion device 30 as a virtual synchronous generator. Specifically, the VSG control unit 321 generates an internal frequency deviation of the virtual synchronous generator, from a deviation between active power Pdet inputted from the measurement value calculation unit 324, which will be described later, and an active power command value inputted from the active power command value limiting unit 322, which will be described later, and further generates a virtual internal phase θvsg from the internal frequency deviation and an external frequency command value Fref, which is one of the command values inputted from the external control device 40.

The active power command value limiting unit 322 is a unit that limits the magnitude of an active power command value, which is one of command values inputted from the external control device 40. Specifically, using an active power command value limit Plim inputted from the active power command value limit calculation unit 323, the active power command value limiting unit 322 generates a second active power command value P'ref finally inputted to the VSG control unit 321.

The active power command value limit calculation unit 323 is a unit that generates (calculates) the active power command value limit Plim that is an active power command value for comparison at the active power command value limiting unit 322, based on a system voltage Vg_det inputted from the measurement value calculation unit 324, which will be described later. Detailed operations of the active power command value limiting unit 322 and the active power command value limit calculation unit 323 will be described later.

The measurement value calculation unit 324 is a unit that based on an output voltage V and an output current I, which are measurement values acquired from the power conversion device 30 through sensors (not illustrated), calculates various voltages, powers, and the like that the VSG control unit 321, the active power command value limiting unit 322, and the active power command value limit calculation unit 323 need. Specifically, based on the output voltage V and the output current I, the measurement value calculation unit 324 calculates the active power Pdet reactive power Qdet, and the system voltage Vg_det of the power conversion device 30, which is the absolute value of the output voltage V.

The AVR control unit 325 is a unit that performs automatic voltage control in the power conversion device 30 as the virtual synchronous generator to generate a virtual internal voltage of the power conversion device as the virtual synchronous generator. Specifically, the AVR control unit 325 generates a virtual internal voltage Eref of the virtual synchronous generator, from the reactive power Qdet inputted from the measurement value calculation unit 324 and a reactive power command value Qref and an external voltage command value Vref, which is one of command values inputted from the external control device 40.

The current command value generation unit 326 is a unit that, for simulation of an impedance of the synchronous generator, has a virtual impedance in the power conversion device 30 as the virtual synchronous generator, and that generates a current command value for the switching control unit 327 at a latter stage, using the virtual impedance. Specifically, the current command value generation unit 326 receives the virtual internal voltage Eref from the AVR control unit 325 and an incoming voltage measurement value, which is unillustrated output from the power conversion device 30, and generates a current command value Iref from these incoming values and the virtual impedance.

The switching control unit 327 is a unit that receives the current command value Iref and an incoming current measurement value, which is unillustrated output from the power conversion device 30, and that generates a switching control signal Dg for carrying out switching control of the inverter 31, based on these incoming values. Specifically, the switching control unit 327 performs the following series of operations. The switching control unit 327 performs current control, such as PID control, based on the current command value Iref, to obtain a desired output current, and acquires the virtual internal phase θvsg inputted from the VSG control unit 321, as a reference phase, and then calculates an inverter voltage command value, based on the output current and the reference phase. Further, the switching control unit 327 carries out PWM control on the inverter voltage command value, thereby generating the switching control signal Dg.

The switching control signal Dg is inputted to a switching element in the inverter 31, where the switching control signal Dg drives the switching element. As a result, DC power of the DC power supply 10 transmitted through the power conversion device 30 is converted into AC power generated by the synchronous generator in a simulated manner and the converted AC power is outputted to the commercial power grid 20.

The power conversion device 30 of the embodiment of the present invention having the above configuration is characterized in that the inverter control unit 32 obtains the final active power command value inputted to the VSG control unit 321, based on the active power command value limiting unit 322 and the active power command value limit calculation unit 323. Hereinafter, the operation of the inverter control unit 32 will be described.

### Operation of Inverter Control Unit

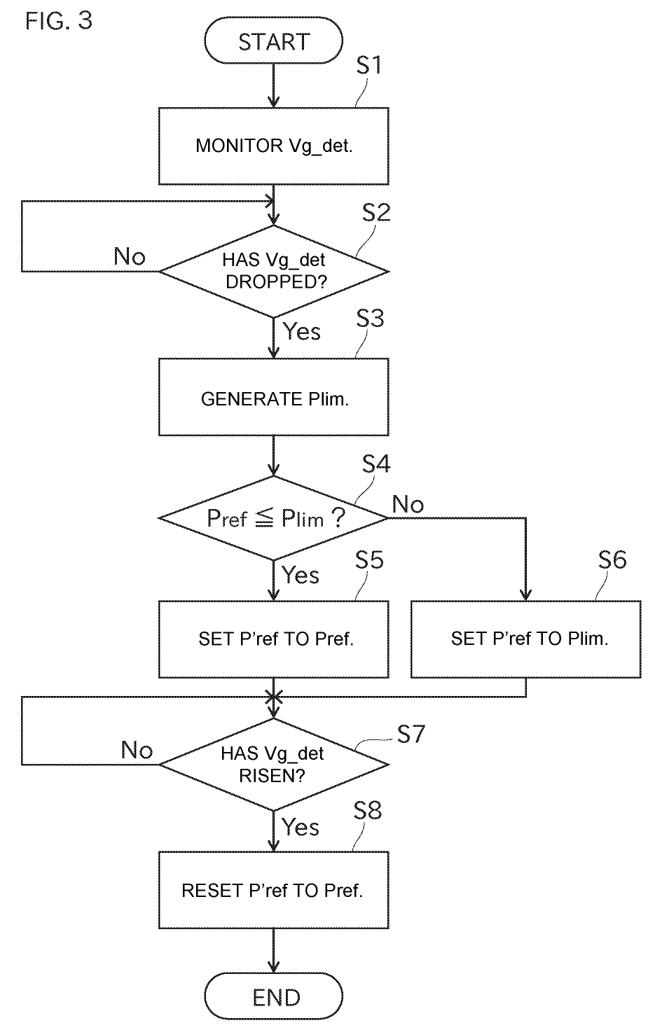

FIG. 3 is a flowchart for describing a control operation of the inverter control unit 32 of the power conversion device 30. As shown in FIG. 3, when the power conversion device starts operating, the active power command value limit calculation unit 323 monitors a change in the system voltage Vg_det inputted from the measurement value calculation unit 324 (step S1), and determines (detects) whether the system voltage Vg_det has dropped in the power supply system 1 (step S2). It is assumed, according to the present invention, that a drop in the system voltage Vg_det is caused by a system short circuit fault or the like. Such a drop in the system voltage Vg_det is determined by, for example, determining whether a degree of drop in the system voltage Vg_det has become larger than a predetermined difference during the monitoring or whether the absolute value of Vg_det has become equal to or smaller than a set given value. It should be noted that whether the system voltage Vg_det has changed may be determined by the active power command value limiting unit 322. This applies also to the following description.

When determining that the system voltage Vg_det has dropped, the active power command value limit calculation unit 323 generates the active power command value limit Plim, based on the system voltage Vg_det, and outputs the active power command value limit Plim to the active power command value limiting unit 322 (step S3). In general, the active power command value limit Plim is set to a value smaller than an active power command value limit Plim before determination of a drop in the system voltage Vg_det, based on a gain-reducing algorithm or the like. For example, Plim may be reduced in accordance with a rate at which Vg_det drops.

Upon receiving input of the active power command value limit Plim from the active power command value limit calculation unit 323, the active power command value limiting unit 322 compares the first active power command value Pref, which is an active power command value the active power command value limiting unit 322 holds at the point of receiving the input, with the active power command value limit Plim (step S4).

When the first active power command value Pref is equal to or smaller than the active power command value limit Plim, the active power command value limiting unit 322 sets the first active power command value Pref as the second active power command value P'ref, and generates the virtual internal phase θvsg, based on the second active power command value P'ref (step S5).

On the other hand, when the first active power command value Pref is larger than the active power command value limit Plim, the active power command value limiting unit 322 sets the active power command value limit Plim as the second active power command value P'ref, which is the active power command value finally inputted to the VSG control unit 321, and generates the virtual internal phase θvsg, based on the second active power command value P'ref (step S6).

The active power command value limit calculation unit 323 continues monitoring a change in the system voltage Vg_det inputted from the measurement value calculation unit 324, and determines (detects) whether the system voltage Vg_det has risen (step S7). It is assumed, according to the present invention, that a rise in the system voltage Vg_det is caused by recovery from a system short circuit fault or the like, and that a time required for the recovery ranges from several 10 milliseconds to 500 milliseconds. Whether the system voltage Vg_det has risen is determined by the same process as executed at step S2.

When it is determined that the system voltage Vg_det has risen, the active power command value limiting unit 322 resets the second active power command value P'ref to the first active power command value Pref that is Pref immediately before determination of a drop in the system voltage Vg_det, and carries out the operation of generating the virtual internal phase θvsg, based on the first active power command value Pref (step S8), and then completes a series of operations.

The above operations at steps S1 to S3 may be replaced with operations described below. When receiving input of the system voltage Vg_det, the active power command value limit calculation unit 323 constantly generates (calculates) the active power command value limit Plim, based on the input, and inputs the active power command value limit Plim to the active power command value limiting unit 322. Upon receiving input of the active power command value limit Plim, the active power command value limiting unit 322 compares the first active power command value Pref, which is an active power command value the active power command value limiting unit 322 holds at the point of receiving the input, with the active power command value limit Plim only when a drop in the system voltage Vg_det is detected.

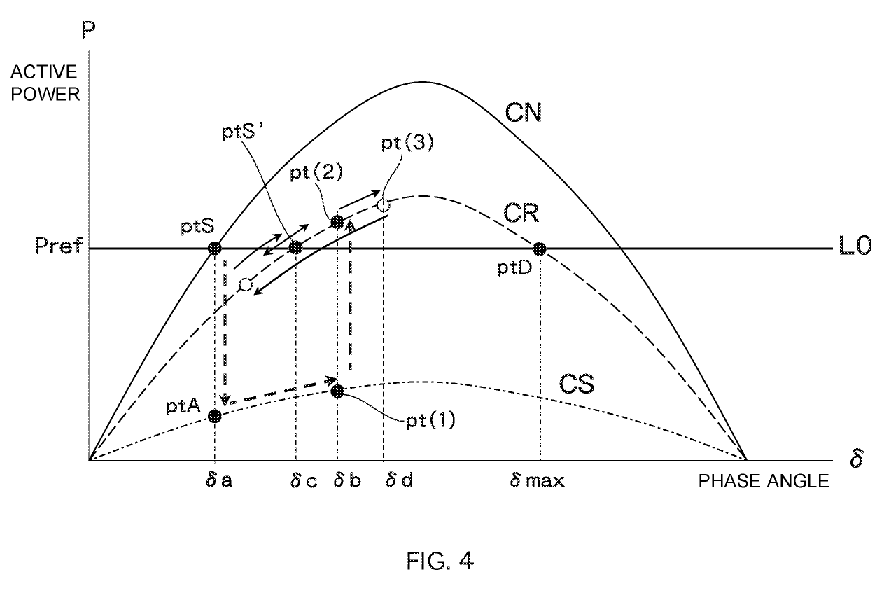

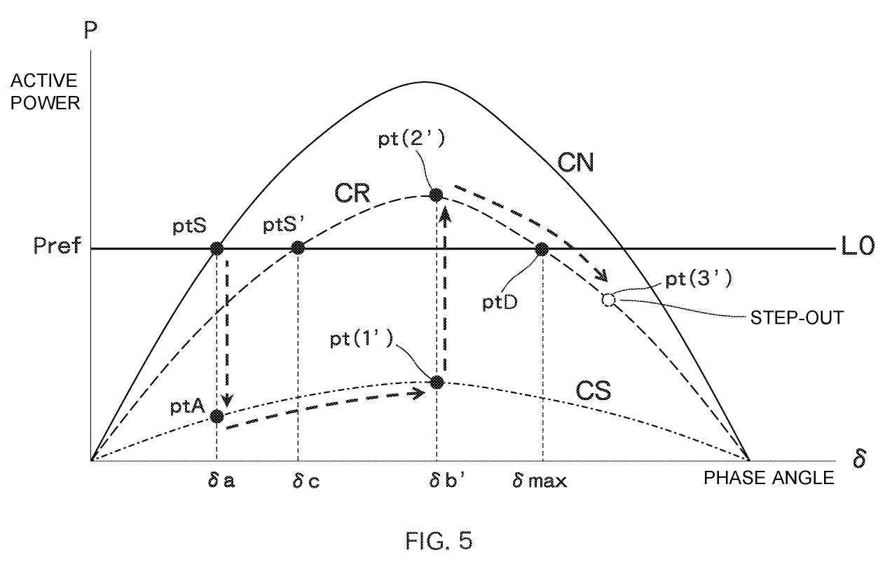

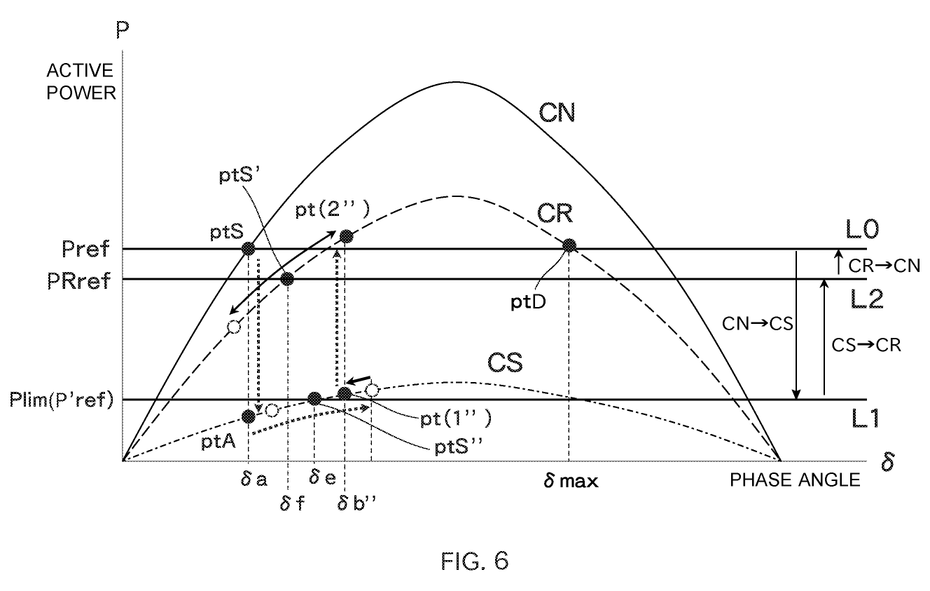

The above series of operations will be further described with reference to transition of an operating point on an active power-phase angle coordinate plane in a conventional power conversion device and in the power conversion device of this embodiment. FIGS. 4 and 5 each depict transition of the operating point in the power conversion device of the conventional configuration, and FIG. 6 depicts transition of the operating point in the power conversion device of this embodiment.

In an initial state where the power supply system 1 runs normally, as shown in FIG. 4, a power-phase angle curve remains a curve CN with a large peak, and an equilibrium point ptS, which is an intersection with the first active power command value Pref before occurrence of a fault, is the operating point. When a drop in the system voltage Vg_det occurs due to a system short circuit fault or the like (step S2), the power-phase angle curve changes to a curve CS with a smaller peak as a result of a drop in active power output. At this time, the operating point transitions to an operating point ptA, which corresponds to the same phase angle δa to which the equilibrium point ptS corresponds, satisfies ptS > ptA, and lies on the curve CS.

In general, a decrease in the peak of the power-phase angle curve in the operation of a real synchronous generator leads to an increase in the rotation frequency. A state similar to this is simulated in a power conversion device as a virtual synchronous generator. As a result, the phase angle δ increases from δa to δb, and the operating point transitions from ptA to pt (1) on the changed curve CS.

Subsequently, when the system voltage Vg_det rises again due to recovery from a system short circuit fault or the like, the active power output too rises again, and in accordance with the power output rising again, the power-phase angle curve changes to a curve CR with a peak larger than the peak of the curve CS. At this time, the operating point transitions to an operating point pt (2), which corresponds to the same phase angle δb to which the operating point pt (1) corresponds and satisfies pt (2) > pt (1). At this time, the active power command value right after the recovery tries to return to the first active power command value Pref. However, because the rotation frequency of the power conversion device as the virtual synchronous generator at the point right after the recovery is larger than the system frequency of the commercial power grid 20, the phase angle changes in the direction of its increase. As a result, the operating point transitions on the curve CR, to an operating point pt (3) corresponding to a phase angle δd larger than the phase angle δb to which the operating point pt (2) corresponds.

When the rotation frequency of the power conversion device as the virtual synchronous generator becomes smaller than the system frequency of the commercial power grid 20 as time further elapses, the phase angle changes in the direction of its decrease. As a result, the operating point transitions on the curve CR, from the operating point pt (3) to a side where the phase angle decreases, and oscillates in such a way as to converge to an equilibrium point PtS’ which is one of two intersections of the curve CR and a straight line L0 representing the first active power command value Pref and is an intersection on a side where the phase angle is smaller (phase angle δc).

However, as indicated in FIG. 5, when recovery from the system short circuit fault or the like takes much time, the operating point transitions in the following manner. In a case where the recovery takes much time, the rotation frequency at the point of the power-phase angle curve having changed to the curve CR further increases. Consequently, the phase angle δ increases from δa to the phase angle δb’, which satisfies δb' > δb, and the operating point transitions from the operating point ptA to an operating point pt (1') on the changed curve CS, which satisfies pt (1') > pt (1).

After recovery from a system short circuit fault or the like, on the curve CR that is the power-phase angle curve, the operating point transitions to an operating point pt (2'), which corresponds to the same phase angle δb' to which the operating point pt (1') corresponds and satisfies pt (2') > pt (1'). However, as in the case of FIG. 4, because the rotation frequency of the power conversion device as the virtual synchronous generator at the point right after the recovery is larger than the system frequency of the commercial power grid 20, the phase angle changes in the direction of its further increase and may exceed a critical angle δmax. This critical angle δmax is a phase angle that gives one intersection out of two intersections of the curve CR and the straight line L0 representing the first active power command value Pref, the one intersection being on a side where the phase angle is larger.

When the operating point exceeds the critical angle δmax, a state in which the rotation frequency of the power conversion device exceeds the system frequency of the commercial power grid 20 continues, which puts the power conversion device into a step-out state in which the power conversion device has lost synchronization as the virtual synchronous generator.

The power conversion device 30 of this embodiment suppresses the occurrence of such a problem by executing the above processes of steps S3 and S4 to S6. When the active power command value limit calculation unit 323 determines that the system voltage Vg_det has dropped, the active power command value limiting unit 322 sets the active power command value limit Plim generated by the active power command value limit calculation unit 323, as the second active power command value P'ref. Then, the VSG control unit 321 generates the virtual internal phase θvsg, based on the set second active power command value P'ref.

Subsequently, as shown in FIG. 6, the active power command value on the coordinate plane defined by the active power output and phase angle is plotted as the second active power command value P'ref satisfying Pref > P'ref, from the first active power command value Pref before a drop in the system voltage Vg_det.

As a result, the operating point of the power conversion device 30 transitions from the operating point ptS that is the operating point before a drop in the system voltage Vg_det, to pt(A), and then temporarily transitions in a direction in which the phase angle increases on the curve CS. However, because the active power command value has been changed to P'ref at step S6, the tendency of increase in the rotation frequency does not continue, and the operating point oscillates in such a way as to converge to an equilibrium point PtS", which is one of two intersections of the curve CS and a straight line L1 representing the second active power command value P'ref and is an intersection on a side where the phase angle is smaller (phase angle δe).

When recovery from the fault is completed as the operation point oscillates about the operation point ptS" on the curve CS and the system voltage Vg_det rises again, the power-phase angle curve changes to the curve CR with the peak larger than the peak of the curve CS in response to the rise of the system voltage Vg_det, and the operating point transitions to the curve CR while keeping the phase angle at the point of the curve having changed to CR. When an operation point is denoted as pt (1") and a phase angle is denoted as δb" at the point of recovery from the fault, the operating point transitions to an operating point pt (2") on the curve CR while keeping the phase angle δb". In FIG. 6, as an example, a phase angle at the point of transition to the curve CR is shown as a phase angle δb" satisfying δb" > δe, and the post-transition operating point corresponding to the phase angle δb" is shown as an operating point pt (2").

Further, the power conversion device 30 of this embodiment executes the above processes of steps S7 and S8. When it is determined that the system voltage Vg_det has risen again, the active power command value limiting unit 322 resets the second active power command value P'ref to a third active power command value PRref, which is an active power command value right after the recovery and satisfies PRref < Pref. Then, the VSG control unit 321 generates the virtual internal phase θvsg, based on the reset third active power command value PRref.

As a result, in the power conversion device 30, a new equilibrium point ptS', which is an intersection of the third active power command value PRref and the curve CR, is formed, as in the case of the conventional configuration shown in FIG. 4, and the operating point oscillating from pt (2") on the curve CR and finally converges to the equilibrium point ptS', at which a stable operation continues with the third active power command value PRref. Thereafter, as in the conventional case, the active power command value returns to the first active power command value Pref in a phased manner from the third active power command value PRref .

In this manner, the power conversion device 30 according to this embodiment suppresses, by setting the second active power command value P'ref even in case of drop of the system voltage Vg_det, increase of the phase angle at the time of re-rising of the system voltage Vg_det by oscillating, as a virtual synchronous generator, the operating point such as to converge to the equilibrium point. This prevents a case where the phase angle increases when the voltage Vg_det rises again. As a result, the operating point’s exceeding the critical angle δmax is prevented, and the power conversion device’s falling into the step-out state, in which the power conversion device has lost synchronization as the virtual synchronous generator, is also prevented.

The above processes of steps S4 and S5 are executed for the following reasons. In the power supply system 1, generation of the active power command value by the external control device 40 is sequential control carried out in pursuant to the operation of the commercial power grid 20 side, and, in general, falls behind a point of time at which the active power command value limit calculation unit 323 generates the active power command value limit Plim.

Because of this, in a time zone right after occurrence of a system short circuit fault or the like (e.g., a timespan of approximately several tens of milliseconds to 500 milliseconds), for example, in the case that the first active power command value Pref right before the occurrence of the fault takes a value of 0, when the active power command value limit Plim is recalculated before the external control device 40 generates a new first active power command value Pref, a relationship Plim > Pref holds, in which case the active power command value limit Plim cannot be used as the second active power command value P'ref. Even in a case where the power supply system 1 is in normal operation in which no system short circuit fault or the like occurs, when the frequency becomes higher than usual due to excessive power supply to the commercial power grid 20, the power conversion device 30 connected to the DC power supply 10 attempts to stop supplying current. In such a situation, when the active power command value limit Plim is generated based on the system voltage Vg_det, the relationship Plim > Pref holds in some cases.

The power conversion device 30 of this embodiment puts the above processes of steps S4 to S5 in the middle of the series of processes, thereby ensuring that when the active power command value limit Plim generated by the active power command value limit calculation unit 323 of the power supply system 1 becomes equal to or larger than the first active power command value Pref at the time of occurrence of a fault, the active power command value limit Plim is not used. This achieves stable control.

In addition, the power conversion device 30 of this embodiment is configured to limit the first active power command value Pref to the active power command value limit Plim as the second active power command value P'ref, by the active power command value limiting unit 322 and the active power command value limit calculation unit 323. This offers the following effects. To prevent step-out, maintaining a state in which the equilibrium point where the power-phase angle curve and the active power command value meet is not lost is preferable. For this approach, a method of manipulating the power-phase angle curve with its peak dropped to raise the peak is considered. This manipulation, however, specifically requires highly technical processing of oscillation equation parameters, such as changing an inertia constant and a braking constant, making a virtual impedance variable, and changing a current saturation algorithm, and a configuration for the processing. In contrast, the power conversion device 30 of this embodiment having the above configuration can prevent the case of getting into the step-out state, using a simpler configuration and processes.

Furthermore, according to the power conversion device 30 of the embodiment of the present invention, when the active power command value limit calculation unit 323 determines that the system voltage Vg_det has risen, the active power command value limiting unit 322 resets the second active power command value P'ref to the first active power command value Pref that is Pref right before determination of the drop in the system voltage Vg_det.

This allows the power conversion device 30 to quickly return to its normal state in response to recovery from a system short circuit fault or the like and operate in a stable manner.

As described above, the present invention can provide the power conversion device that, even when a system short circuit fault occurs, can prevent the power conversion device as a virtual synchronous generator from falling into a step-out state.

### Modifications

In the power conversion device 30 according to the embodiment of the present invention, the active power command value limiting unit 322 is configured to use the active power command value limit Plim limited by the active power command value limit calculation unit 323, as the second active power command value P'ref replacing the first active power command value Pref. However, configurations the present invention provides are not limited to this configuration.

What is required is that the power conversion device of the present invention be configured such that when a drop in a voltage of the system is detected, the active power command value limiting unit that limits the magnitude of the active power command value inputted from outside to the inverter control unit performs limitation that makes the active power command value smaller than the active power command value before the detection. The configuration of the power conversion device is therefore not limited by a specific method of limitation executed by the active power command value limiting unit.

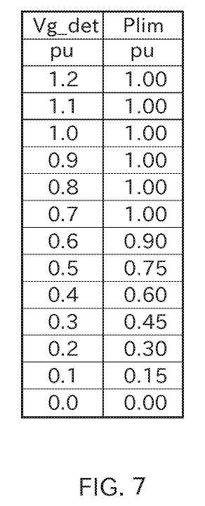

For example, a configuration in which the inverter control unit 32 dispenses with the active power command value limit calculation unit 323 may be provided. In this configuration, when a rise in the system voltage Vg_det is detected, the active power command value limiting unit 322 may limit the magnitude of the active power command value inputted from outside to a magnitude smaller than the magnitude of the active power command value before the detection, according to a conversion table stored in the active power command value limiting unit 322 or any one of other blocks of the inverter control unit 32. FIG. 7 shows an example of the conversion table. In this case, using a predetermined fixed value listed in the conversion table allows processing with a high processing speed. Therefore, even a low spec calculation unit can handle the calculation to limit the active power command value, and realizing cost reduction.

The active power command value limiting unit 322 may perform limitation such that after detection of drop in a voltage of the commercial power grid 20, the active power command value is caused to change in such a way as to decrease with time and that when the voltage of the commercial power grid 20 having risen again is detected, the active power command value is caused to return to a value before the limitation. In this case, by causing the active power command value to change in such a way as to decrease with time, the active power command value can be made smaller than the active power command value before the detection in a simpler configuration.

When it is determining that the system voltage Vg_det has risen, the active power command value limiting unit 322 resets the second active power command value P'ref to the third active power command value PRref which is the active power command value right after recovery. In this case, however, the second active power command value P'ref may be reset to the first active power command value Pref. That is, when the system voltage Vg_det having risen again is detected after the magnitude of the active power command value is limited, the active power command value limiting unit 322 may cause the active power command value to return to any given value larger than the limited active power command value.

In the above description, the power conversion device of the present invention is connected to the commercial power grid 20 as the system. According to the present invention, however, the power conversion device may be connected to any given system. Therefore, the system may be a distributed power supply, which includes other power conversion devices, or another smart grid, and is not limited by the specific configuration of a power supply making up the system, a control method, or the like. It should be noted, however, that in the present invention, employing a commercial power grid as the system facilitates setting the active power command value limit Plim as a significant value and is therefore preferable.

The embodiment of the present invention has been disclosed herein by the above description, but the present invention is not limited to this embodiment.

The above-described embodiment and modification may be modified in various forms in terms of procedure, shape, material, quantity, position, arrangement, etc., without departing from the scope of the technical idea and object of the present invention, and such modifications are included in the present invention.

What is claimed is:

1. A power conversion device comprising:
an inverter that converts DC power of a DC power supply into AC power and that outputs the AC power to a system; and
an inverter control unit that controls the inverter by virtual synchronous generator control simulating driving of a synchronous generator based on an active power command value,
wherein the inverter control unit includes an active power command value limiting unit that when a drop in a voltage of the system is detected, limits a magnitude of the active power command value inputted from outside to the inverter control unit,
the active power command value limiting unit performs limitation that makes the active power command value smaller than the active power command value before the detection, and
the inverter control unit controls the inverter based on the active power command value limited by the active power command value limiting unit.

2. A power conversion device comprising:
an inverter that converts DC power of a DC power supply into AC power and that outputs the AC power to a system; and
an inverter control unit that controls the inverter by virtual synchronous generator control simulating driving of a synchronous generator based on an active power command value,
wherein the inverter control unit includes:
an active power command value limiting unit that when a drop in a voltage of the system is detected, limits a magnitude of the active power command value inputted from outside to the inverter control unit; and
an active power command value limit calculation unit that generates an active power command value limit Plim that is an active power command value for comparison, the active power command value limit Plim being set based on a voltage of the system, and
the active power command value limiting unit
compares a first active power command value Pref that is the active power command value inputted from the outside with the active power command value limit Plim,
when Pref ≤ Plim holds, sets the first active power command value Pref to a second active power command value P’ref that is the active power command value satisfying P'ref = Pref, and
when Pref > Plim holds, limits the first active power command value Pref to the active power command value limit Plim, as the second active power command value P’ref.

3. The power conversion device according to claim 1, wherein the active power command value limiting unit limits a magnitude of the active power command value inputted from outside to a magnitude smaller than a magnitude of the active power command value before the detection, according to a conversion table stored in the inverter control unit.

4. The power conversion device according to claim 1, wherein when a voltage of the system having risen again is detected after a magnitude of the active power command value is limited, the active power command value limiting unit causes the active power command value to return to a value larger than the limited active power command value.

5. The power conversion device according to claim 2, wherein when a voltage of the system having risen again is detected after a magnitude of the active power command value is limited, the active power command value limiting unit causes the active power command value to return to a value larger than the limited active power command value.

6. A power conversion device comprising:
an inverter that converts DC power of a DC power supply into AC power and that outputs the AC power to a system; and
an inverter control unit that controls the inverter by virtual synchronous generator control simulating driving of a synchronous generator based on an active power command value,
wherein the inverter control unit includes an active power command value limiting unit that when a drop in a voltage of the system is detected, limits a magnitude of the active power command value inputted from outside to the inverter control unit,
the active power command value limiting unit performs limitation such that after a drop in the voltage of the system is detected, the active power command value is caused to change in such a way as to decrease with time and that when the voltage of the system having risen again is detected, the active power command value is caused to return to a value larger than the limited active power command value, and
the inverter control unit controls the inverter based on the active power command value limited by the active power command value limiting unit.

7. The power conversion device according to claim 1, wherein the system is a commercial power grid.

8. The power conversion device according to claim 2, wherein the system is a commercial power grid.

9. The power conversion device according to claim 5, wherein the system is a commercial power grid.
